(19) United States
(12) Patent Application Publication
(10) Pub. No.: US 2011/0254688 A1
(43) Pub. Date: Oct. 20, 2011

(54) USER STATE RECOGNITION IN A WIRELESS COMMUNICATION SYSTEM

(75) Inventors: Yury Nikolaevich PRIBYTKOV, Voronezh (RU); Jung-Hwan Lee, Middlesex (GB); Mahmoud Hadef, Middlesex (GB); Alexander Vasilevich Garmonov, Voronezh (RU); Sergey Nikolaevich Moiseev, Voronezh (RU); Artem Nikolaevich Khramov, Voronezh (RU)

(73) Assignee: Samsung Electronics Co., Ltd., Suwon-si (KR)

(21) Appl. No.: 13/087,818

(22) Filed: Apr. 15, 2011

(30) Foreign Application Priority Data
Apr. 15, 2010 (RU) 2010115043
Mar. 31, 2011 (KR) 10-2011-0029659

(51) Int. Cl. G08B 21/00; G10L 21/00

(52) U.S. Cl. 340/540; 704/500

(57) ABSTRACT

A method for user state recognition, of a user equipment having a microphone, in a wireless communication system, is provided where the microphone receives audio signals, the received audio signals are divided into segments, an audio signal level indicator for each audio signal segment is calculated and a user state is set to a first state, dependent on a value of at least one said audio signal level indicator being less than a predefined threshold.

### PRIORITY

This application claims priority under 35 U.S.C. §119(a) to an application filed in the Russian Intellectual Property Office on Apr. 15, 2010 and assigned Serial No. 2010115043, and filed in the Korean Intellectual Property Office on Mar. 31, 2011, and assigned Serial No. 10-2011-0029659, the entire disclosure of which is incorporated herein by reference.

### BACKGROUND OF THE INVENTION

1. Field of the Invention

The present invention relates generally to wireless communication systems, and more particularly, to a method and apparatus for user state recognition in a wireless communication system by analyzing audio signals received by a mobile device microphone and can be applied in GSM, CDMA, IEEE 802.16, IEEE 802.11n, 3GPP LTE and other wireless communication systems.

2. Description of the Related Art

Wireless communication systems typically include mobile devices that are mainly used to provide communication with base stations and are able to perform multiple other functions. These functions include communication with different devices and equipment, communication with Global Positioning Systems (GPS), entertainment functions such as playing music and games, user alert systems, and the like.

User state recognition in a wireless communication system plays an important practical role in extending mobile device functionality. The possible user states include indoor or outdoor states, and stationary or moving states and determining these states may provide additional ways to extend mobile device functionality.

For example, mobile device battery power can be saved, by switching off communication with the GPS, when the user is indoors. Another example is improving the user alert system embedded in many mobile devices which informs the user that certain actions should be taken depending on mobile device state. Yet another example is a sound volume adaptation system used depending on whether the user is walking, driving or is stationary in a quiet indoor environment. Another example is call forwarding from the mobile phone to a hands-free automatic audio playback device while driving.

Known approaches to user state recognition include methods based on determining user location using global navigation systems, for example Global Positioning System (GPS), Standard Positioning Service, Signal Specification, (2nd Edition, 46 p., Jun. 2, 1995). However, user location cannot always be provided by such systems because global navigation system signals are not always available. Moreover, determining user location in multi-path environments may have a high error rate. This is especially typical of determining user location in urban environments. In these conditions the possibility of determining some user states in a wireless communication system using other means may provide a valuable advantage.

Current user state recognition techniques also include methods based on user location provided both by GPS and base station signal strength (see, for example, “Location System And Method”, UK Patent Application, GB 2454939 A, published May 27, 2009). Base station signal strength may vary highly depending on different obstacles such as slow (log-normal) fading of radio signal strength. In this case errors in user location may reach hundreds of meters. These errors may make it impossible to detect whether the user is indoors or outdoors.

Other user state recognition methods known are based on signals from miniature built-in mechanic devices such as 2D accelerometer (see, for example, “Techniques For Determining Communication State Using Accelerometer Data”, US Patent Application, 2006/0187847 A1, published Aug. 24, 2006 to Cisco Technology, Inc.). The accelerometer can be used to determine whether the user is stationary or moving. This method has at least two drawbacks. First, it requires upgrading the mobile device hardware, which essentially entails creating a new mobile device. This may increase mobile device cost and make it incompatible with available similar mobile devices. The second drawback is the typically quite high sensitivity of miniature mechanical systems to physical impact. For example, if the user drops the mobile phone, the mechanical device inside is likely to be broken.

Some user state recognition methods are based on statistical analysis of radio signals from base stations in the wireless communication system (see, for example, “Apparatus And Methods Using Radio Signals”, US Patent Application, 2009/0227271 A1, published Sep. 10, 2009). A drawback of this approach is strong dependence of base station signal levels on multiple uncontrolled factors. This may lead to very low reliability of user state recognition based on base station signal levels in the wireless communication system and reliability may be increased by increasing observation time. The statistics accumulated over a long observation time provide more reliable user state recognition. However, a longer observation time (typically 10-15 minutes) may cause long delays in making a decision about the user state which can make the decision outdated or even useless.

Due to the above disadvantages of the known solutions for recognizing some user states in the wireless communication system, there may be an advantage in using techniques which do not require mobile device hardware upgrade and are based only on software upgrade.

Prior art related to the claimed method includes the solution, described in: Ian Anderson, Henk Muller “Context Awareness via GSM Signal Strength Fluctuation”, The 4th International Conference on Pervasive Computing, ISBN 3-85403-207-2, pp. 27-31, May 2006. In this method at least one base station and at least one user mobile device are used, wherein user states are estimated periodically over a specified period of time (once a second), where in each cycle, the number of transmitting base stations visible to the user mobile device are measured, the power of signal from one or several base stations is measured, the power of signals received from all base stations is summed thus obtaining two realizations of total signal power and number of base stations, the obtained realizations of total signal power and number of base stations are transmitted to embedded pre-configured and trained neuron network with eight hidden elements, the neuron network weights the obtained two realizations with different weights therefore forming a user state estimate to be transmitted to the user mobile device.

The prior art method has at least the following disadvantage, where the prior art method uses base station signal strength to determine user states. As mentioned above, base station signal strength strongly depends on multiple uncontrollable factors. This leads to very low reliability of user state recognition based on base station signal strength estimation in the wireless communication system. This reliability may be increased only by increasing observation time. The statistics accumulated over a long observation time provides more reliable user state recognition. However, longer observation time (10-15 minutes) causes long delays in making a decision about the user state which can make the decision outdated or even useless.

### SUMMARY OF THE INVENTION

An aspect of the present invention is to address at least the above-mentioned problems and/or disadvantages and to provide at least the advantages described below.

Accordingly, an aspect of the present invention is to provide a method for user state recognition in a wireless communication system comprising a user equipment having a microphone where the microphone is used to receive audio signals, dividing the received audio signals into segments, calculating an audio signal level indicator for each segment and setting a user state to a first state, dependent on a value of at least one said audio signal level indicator being less than a predefined threshold.

Another aspect of the present invention is to provide user equipment for use in a wireless communication system, the user equipment having a microphone, and the user equipment being arranged to divide the received audio signals into segments, calculate an audio signal level indicator for each segment, and set a user state to a first state, dependent on a value of at least one said audio signal level indicator being less than a predefined threshold.

Yet another aspect of the present invention is to provide a computer program product comprising a non-transitory computer-readable storage medium having computer-readable instructions stored thereon, the computer readable instructions being executable by a computerized device to cause the computerized device to perform a method for user state recognition in a wireless communication system comprising a user equipment having a microphone by using the microphone to receive audio signals, dividing the received audio signals into segments, calculating an audio signal level indicator for each segment, and setting a user state to a first state, dependent on a value of at least one said audio signal level indicator being less than a predefined threshold.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a flow diagram of an algorithm according to an embodiment of the invention for user state recognition in wireless communication systems;

FIG. 2 is a diagram illustrating typical amplitude of audio signals measured near a road in a city;

FIG. 3 is a diagram illustrating typical amplitude of audio signals measured in an office;

FIG. 4 is a diagram illustrating typical autocorrelation functions of audio signals measured in an office and near a road;

FIG. 5 is a diagram illustrating typical power spectral densities of audio signals in decibel measured in an office and near a road;

FIG. 6 is a diagram illustrating indicators of audio signal levels, in particular, standard deviations of audio signals measured in an office and near the road during 4.5 seconds; and

FIG. 7 is a diagram illustrating sliding minima of a hundred consecutive standard deviations of audio signals measured in an office and near the road during 4.5 seconds as well as a threshold.

### DETAILED DESCRIPTION OF EMBODIMENTS OF THE PRESENT INVENTION

Various embodiments of the present invention will be described in detail below with reference to the accompanying drawings. In the following description, specific details such as detailed configuration and components are merely provided to assist the overall understanding of the embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

In the following detailed description, embodiments of the invention are described in the context of a mobile handset, that is, user equipment, in a cellular wireless system. However, it will be understood that this is by way of example only and that other embodiments may involve other types of wireless network or wireless communication system terminals and other types of mobile terminals, for example portable computers.

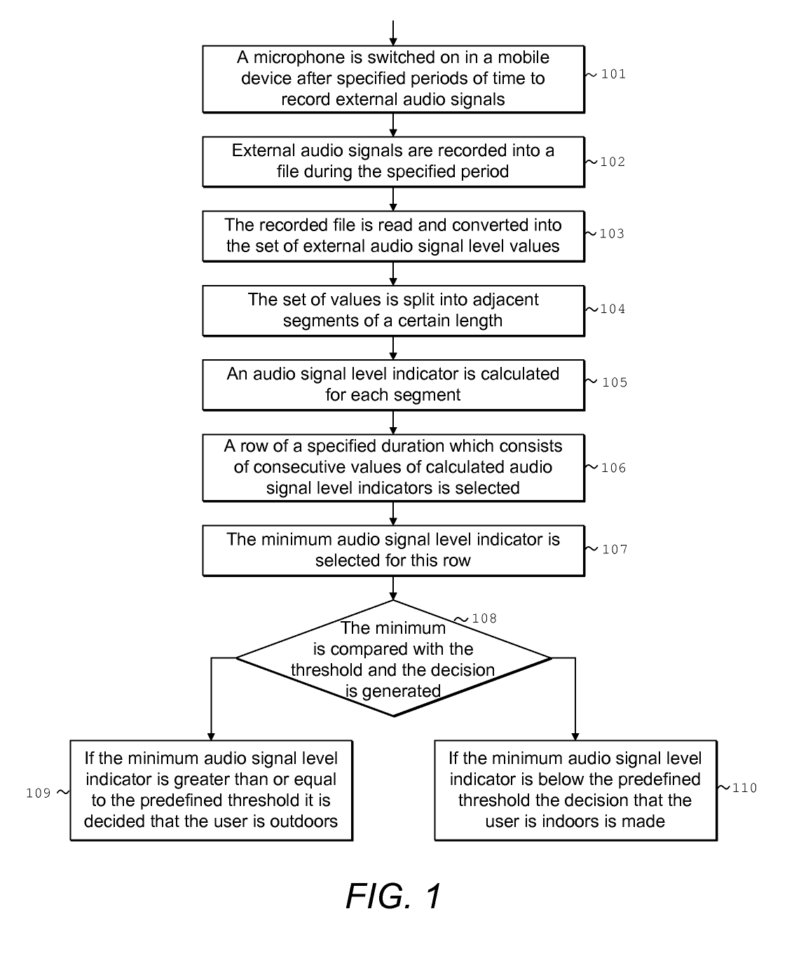

An embodiment of the invention may be implemented on user equipment, such as a mobile device, using the procedure illustrated by FIG. 1. In FIG. 1, it is assumed that the user mobile device comprises at least a built-in microphone and a computation module (processor unit). In Step 101, the microphone may be switched on in the mobile device after specified periods of time, for example, by means of software, to receive external audio signals that may be recorded in Step 102. Such receiving may for example be a monitoring of external audio signals. Using the computation module, external audio signals may be recorded, for example, into a standard “way” file during a specified period of time. Typically once the recording is over, the way file may be read and converted in Step 103 into a set of external audio signal level values and the set of values may be split into segments, in Step 104 typically adjacent segments, of a certain length. An audio signal level indicator, for example, a standard deviation of audio signal level within a segment, may be calculated for each segment in Step 105, and a row of a specified duration, that is to say a set of segments, which consists of consecutive values of calculated audio signal level indicators i.e. standard deviations of audio signal levels may be selected in Step 106, the minimum audio signal level indicator may be selected for this row in Step 107 and compared with a predefined threshold in Step 108, and as a result a decision relating to the state of the user mobile device may be generated. If the minimum indicator value is below the predefined threshold the decision that the user mobile device is indoors may be made, and the user state indicator is set to a first state in Step 110, and if the minimum indicator is greater than or equal to the predefined threshold it may be decided that the user mobile device is outdoors, and the user state is set to a second state in Step 109.

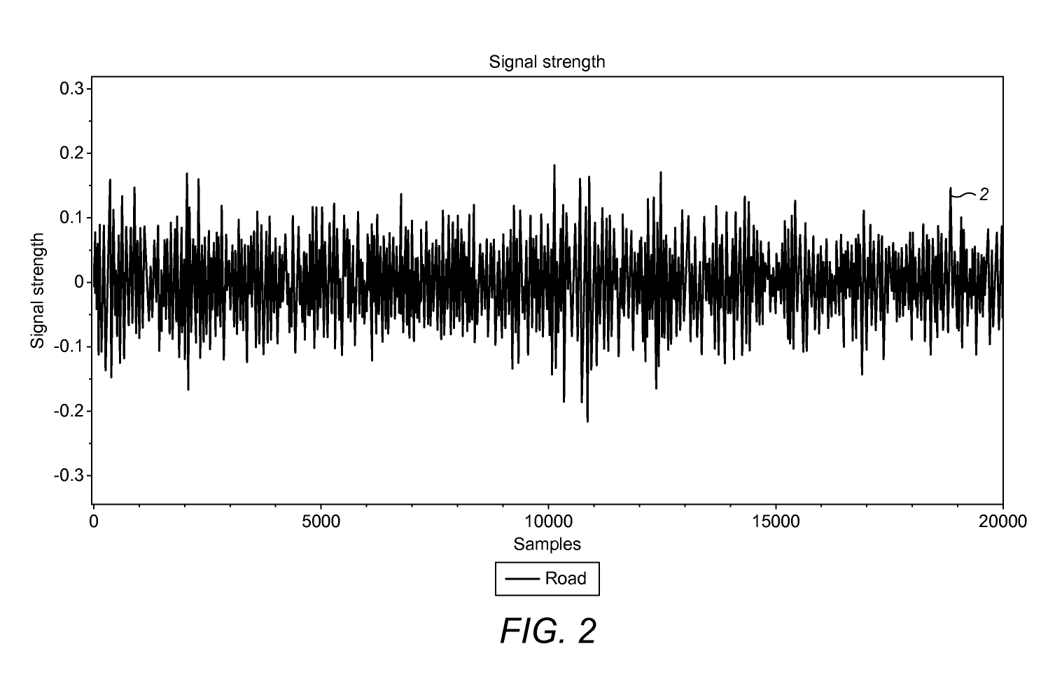

Embodiments of the invention will now be considered in more detail by reference to FIGS. 2 to 7.

Acoustic noise in an office as opposed to outdoors, particularly, but not exclusively, in an urban environment, for example, near a road can have noticeably different statistical characteristics. Acoustic noise close to a busy city road is generally much higher in power than that in the office. The spectral content of noise may also be different between the two types of location. Thus in embodiments of the invention, a rule may be applied for discriminating between two user states, i.e. an indoor state (e.g. in an office) and an outdoor state (e.g. close to a busy city road) based on audio signals measured by a user mobile device.

Since many mobile devices have a built-in microphone, acoustic noise may be measured without hardware upgrade. Measured audio signals may be recorded into way files by means of the computation module. From the way files the signals may be decoded into initial audio signal strength realizations. It may not be necessary to record the received audio signals; the signals may be divided into segments in real time and an audio level indicator may be calculated for each segment, or the calculation may be performed in a sliding time window.

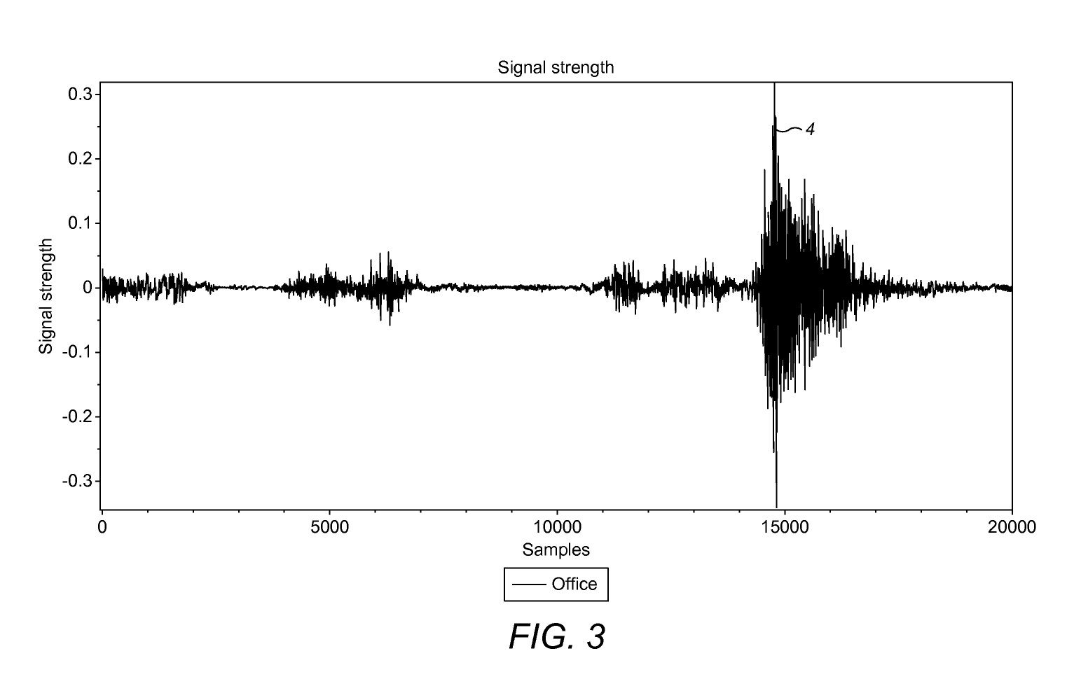

In order to perform statistical analysis of audio signals, field tests have been performed to obtain signal measurements, that is to say realizations, near a road and in an office, as shown in FIGS. 2 and 3 respectively, for a chosen sampling frequency and time interval between two neighbor measured values. Since the acoustic noise in the office is essentially a non-stationary stochastic process, separate typical parts of its realizations have been identified and a preliminary classification has been performed.

FIGS. 2 and 3 are diagrams illustrating two typical measured realizations 2, 4 of the audio signals for cases when the mobile device is outdoors 2, near a road, as shown in FIG. 2, and indoors 4, in an office, as shown in FIG. 3. The sample size is 10000 samples for each realization which corresponds to 0.45 sec.

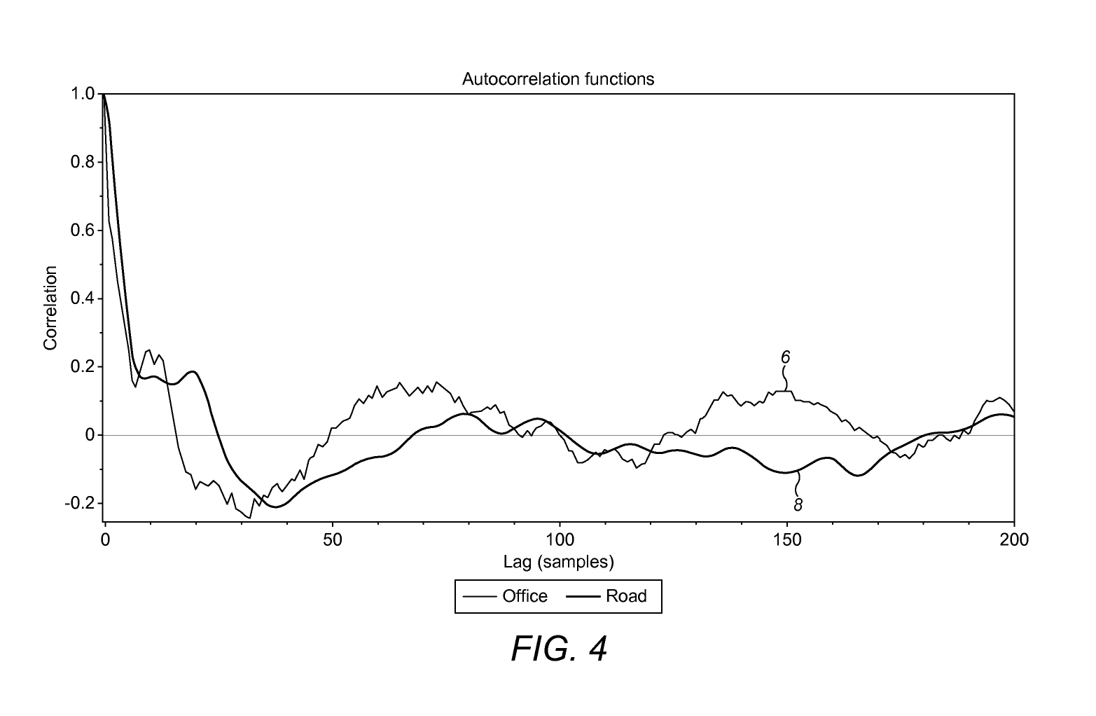

The above diagrams illustrate that average amplitudes of audio signals indoors, i.e. in the office can be both lower or higher, at different times, than average amplitudes of signals outdoors, e.g. on the roadside. FIG. 4 is a diagram illustrating typical normalized autocorrelation functions of the respective audio signals 6, 8. FIG. 4 is a diagram illustrating that audio signal autocorrelation functions measured indoors 6 and outdoors 8 may not be essentially different.

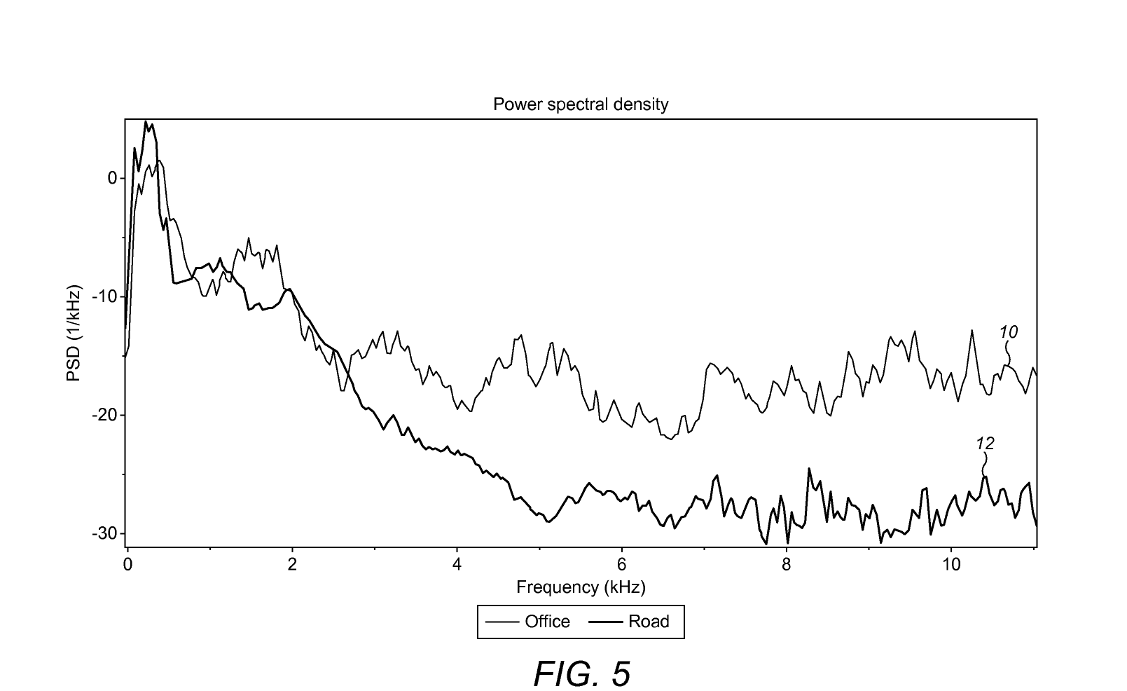

A common approach to acoustic noise analysis is based on studying spectral rather than correlation characteristics of audio signals. FIG. 5 is a diagram illustrating the power spectral density estimates of the measured audio signals in the range from 0 Hz to the maximum Nyquist frequency

$$\frac{Fs}{2} ,$$

where Fs is a sampling frequency.

FIG. 5 clearly illustrates that the main strength of the measured signals focuses in the range of 0-1 kHz. FIG. 5 also illustrates that the spectral content of the audio signals in the office 10 and on the roadside 12 is a little different although the patterns of this difference may be hard to establish due to a limited amount of analyzed data.

From the above FIGS. 2-5 we can see that the user state discrimination algorithm based on the difference between correlation or spectral properties of acoustic noise indoors and outdoors may be rather complex due to similar correlation function shapes and spectral densities corresponding to these states.

Thus in an embodiment of the invention, the claimed user state recognition method may be implemented in the wireless communication system based on the difference in fluctuation values of audio signals, for example, between indoors, for example in the office, and outdoors, for example near a road.

Acoustic noise in urban environments is quite high and typically has virtually no pauses, due to numerous cars and other noise factors. Indoor acoustic noise is usually caused by a conversation of one or a few people. Normally short pauses occur during the conversation. In embodiments of the invention, user state recognition in the wireless communication system is based on an indoor and outdoor audio signal recognition algorithms implementing a “silence search” or quiet search idea, i.e. a search for short time periods when relatively low audio signal level is observed, not necessarily zero. If these periods are found, the decision that the user is indoors may be made. Otherwise it may be decided that the user is outdoors.

A sampling standard deviation of acoustic noise, that is to say received audio signals, calculated on the set interval may be used as a measure function of the acoustic noise level.

Let xᵢ denote acoustic noise realization, that is to say received audio signals. Then the sample estimate of the audio signal level indicator, i.e the standard deviation of audio signal on interval L is

$${SD}_{t} = \sqrt{\frac{1}{L - 1} {\sum }_{i = t + 1}^{t + L} {( {x}_{i} - {μ}_{i} )}^{2}}$$

where μ is the average audio signal value on interval L. The algorithm for user state recognition may include the following steps.

In the first step K audio signal standard deviation values on the adjacent intervals are calculated

$${SD}_{0} = \sqrt{\frac{1}{L - 1} {\sum }_{i = 1}^{L} {( {x}_{i} - {μ}_{i} )}^{2}} , \\ {SD}_{1} = \sqrt{\frac{1}{L - 1} {\sum }_{i = L + 1}^{2 L} {( {x}_{i} - {μ}_{i} )}^{2}} , \\ {SD}_{2} = \sqrt{\frac{1}{L - 1} {\sum }_{i = 2 L + 1}^{3 L} {( {x}_{i} - {μ}_{i} )}^{2}} , \\ … , \\ {SD}_{K - 1} = \sqrt{\frac{1}{L - 1} {\sum }_{i = ( K - 1 ) L + 1}^{KL} {( {x}_{i} - {μ}_{i} )}^{2}} .$$

As a result we have K standard deviation values on the adjacent time intervals:

SD₀, SD₁, . . . , SD_{K-1}.

In a particular case the value K=100 can be selected. Thus the total interval required to make a decision is K·L samples which corresponds to 4.5 sec.

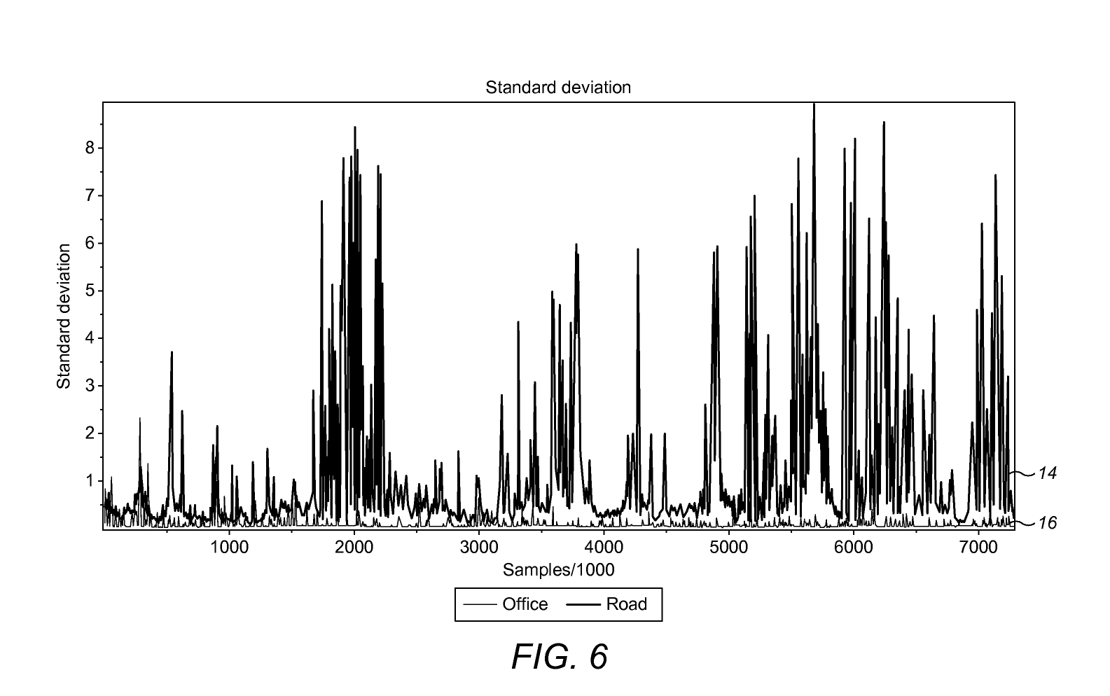

FIG. 6 depicts typical standard deviation estimates for audio signals measured in the office 16 and outdoors 14, near the road. This figure illustrates that standard deviations of audio signals measured in the office can, on occasion, be higher than those measured outdoors, near the road. Thus to reduce the possible errors in user state recognition the next step may be used.

In the second step the minimum out of K standard deviations of audio signal levels is calculated:

SDₘᵢₙ=min{SD₀, SD₁, . . . , SD_{K-1}}.

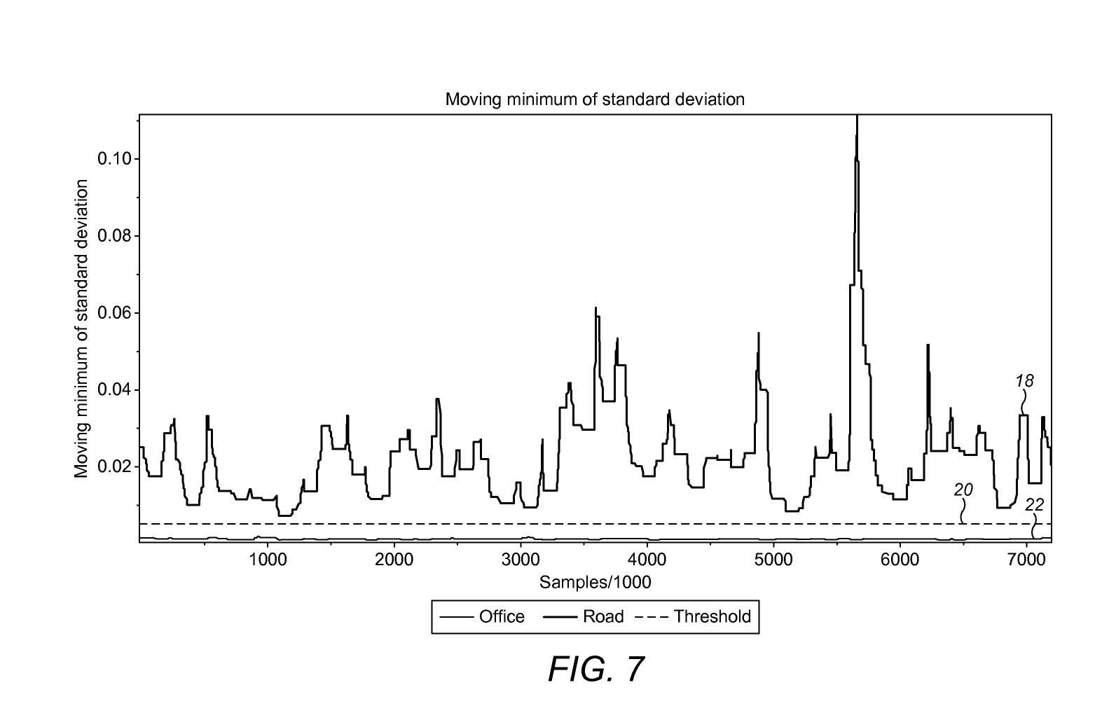

FIG. 7 is a diagram illustrating typical minimum indicator values of audio signals measured in the office 22 and near the road 18. FIG. 7 illustrates that minimum values of audio signal levels measured in the office are typically not higher than those measured near the road.

In the third step minimum audio signal level indicators are compared with a threshold 20, that is to say predefined threshold, h and the decision is generated based on comparison results. The threshold value may be obtained by an experiment. The decision may be generated as follows.

If the minimum audio signal level indicator SDₘᵢₙ is below threshold h, it may be decided that the user mobile device is indoors, e.g. in the office.

If the minimum audio signal level indicator SDₘᵢₙ is over or equal to threshold h, it may be decided that the user mobile device is outdoors, e.g. near the road. It is not necessary for the outdoor location to be near a road; the acoustic environment at other outdoor locations may have similar properties. For example, there may be a relatively constant level of noise with relatively few quiet or silent periods.

FIG. 7 illustrates typical minimum indicators of audio signal levels measured in the office 22 and near the road 18 as well as the threshold 20. FIG. 7 demonstrates that the minimum indicators of audio signal levels measured in the office are below the specified threshold and the minimum indicators of audio signal levels measured outdoors, e.g. near a road are over the specified threshold. Thus, in this example, for these audio signal realizations the proposed algorithm of the claimed method makes correct decisions with zero error.

Embodiments of the invention can also be implemented on a user portable computer according to the above algorithm. In this case the portable computer should have a microphone and a computation module (processor-module), which is available in almost every computer.

While the present invention has been shown and described with reference to certain embodiments above, it will be understood by those skilled in the art that various changes in form and details may be made therein without departing from the spirit and scope of the invention as defined by the appended claims.

What is claimed is:

1. A method for user state recognition, of a user equipment having a microphone, in a wireless communication system, the method comprising:
using the microphone to receive audio signals;
dividing the received audio signals into segments;
calculating an audio signal level indicator for each audio signal segment; and
setting a user state to a first state, dependent on a value of at least one said audio signal level indicator being less than a predefined threshold.

2. A method of claim 1, wherein setting a user state to a first state comprises:
determining the minimum value of the audio signal level indicator for a set of audio signal segments; and
comparing the minimum value with the predefined threshold, wherein setting the user state to the first state depends on the minimum value being less than the predefined threshold.

3. The method of claim 1, wherein the audio signal segments are adjacent segments.

4. The method of claim 2, wherein the audio signal segments are adjacent segments.

5. The method of claim 1, wherein the first state indicates that the user equipment is indoors.

6. The method of claim 2, wherein setting the user state to a first state further comprises:
setting the user state to a second state, dependent on the minimum value of the audio signal level indicator being greater than or equal to the predefined threshold.

7. The method of claim 6, wherein the second state indicates that the user equipment is outdoors.

8. The method of claim 1, wherein the audio signal level indicator for each segment is determined from the recorded received audio signals.

9. The method of claim 2, wherein the minimum value of the audio signal level indicator corresponds to a Standard Deviation of audio levels within the respective segment of the received audio signals.

10. The method of claim 9, wherein the Standard Deviation (SDt) is calculated with following equation:
$${SD}_{t} = \sqrt{\frac{1}{L - 1} {\sum }_{i = t + 1}^{t + L} {( {x}_{i} - {μ}_{i} )}^{2}}$$
where xₜ is the received audio signals and μ is the average audio signal value on interval L.

11. A user equipment for use in a wireless communication system, comprising:
a microphone, used to receive audio signals;
a processor unit, used to divide the received audio signals into segments, calculate an audio signal level indicator for each segment, and set a user state to a first state dependent on a value of at least one said audio signal level indicator being less than a predefined threshold.

12. The user equipment of claim 11, wherein the processor unit sets the user state to a first state dependent on a minimum value of the audio signal level indicator being less than a predefined threshold, and the first state indicates that the user equipment is indoors.

13. The user equipment of claim 11, wherein the processor unit sets the user state to a second state dependent on the audio signal level indicator being greater than or equal to the predefined threshold.

14. The user equipment of claim 13, wherein the processor unit sets the user state to a second state dependent on minimum value of the audio signal level indicator being greater than or equal to the predefined threshold, and the second state indicates that the user equipment is outdoors.

15. A non-transitory computer-readable storage medium having computer-readable instructions stored thereon, the computer readable instructions being executable by a computerized device to control the computerized device to perform a method for user state recognition in a wireless communication system comprising a user equipment having a microphone, the method comprising:
using the microphone to receive audio signals;
dividing the received audio signals into segments;
calculating an audio signal level indicator for each segment; and
dependent on a value of at least one said audio signal level indicator being less than a predefined threshold, setting a user state to a first state.

16. The non-transitory computer-readable storage medium of claim 15, wherein the user state is set to a first state dependent on a minimum value of said audio signal level indicator being less than a predefined threshold, and the first state indicates that the user equipment is indoors.

17. The non-transitory computer-readable storage medium of claim 15, wherein the user state is set to a second state dependent on value of said audio signal level indicator being greater than or equal to the predefined threshold, and the second state indicates that the user equipment is outdoors.
